(19) United States
(12) Patent Application Publication
(10) Pub. No.: US 2003/0157343 A1
(43) Pub. Date: Aug. 21, 2003

(54) Silicone-gum product and a process for manufacturing a silicone-gum product

(76) Inventor: Ricky K. C. Yeung, Hong Kong (CN)

Correspondence Address: Stephen E. Feldman, P.C., 12 East 41st street, new york, NY, 10017, US

(21) Appl. No.: 10/292,186

(22) Filed: Nov. 12, 2002

(30) Foreign Application Priority Data
Jan. 30, 2002 (CN) 02102780.3

(51) Int. Cl. B32B 9/04

(52) U.S. Cl. 428/447

(57) ABSTRACT

The present invention provides a silicone-gum product that may be used in cooking and baking and methods for making a silicone-gum product. The silicone-gum product comprises a glass fiber layer positioned within a silicone rubber and may be used as a non-stick pad or a mold for baking and cooking food products.

### RELATED APPLICATION

This application claims priority from Chinese Patent Application No. 02102780.3, filed on Jan. 30, 2002, the disclosure of which is incorporated by reference herein in its entirety.

### FIELD OF THE INVENTION

The present invention relates to a silicone-gum paper, a process for manufacturing silicone-gum paper and the use of silicone-gum paper for cooking and baking food products.

Background Art

In the traditional operation for cooking and baking food products, ordinary paper is usually used as a pad that is put under the bottom of a food product or around a food product to be cooked and/or baked (referred to as pad paper hereinafter). However, after the food product is cooked and/or baked, the pad paper typically sticks together with the food product, which may occur due to penetration of oil and water from the food into the paper making it difficult to peel the pad paper from the cooked and/or baked food product. In addition, a part of the food product is often removed with the pad paper during peeling, thus causing food product to be wasted.

Furthermore, a great amount of paper is used for the traditional cooking and baking industry of food products and most of the paper is discarded after being used. The use of pad paper in this manner is extravagant and does not accord with the aim of environmental protection.

Therefore, it is desirable to develop a substitute for the traditional pad paper that may be used to bake and/or cook food while providing the same advantages of the pad paper in baking and cooking.

### SUMMARY OF THE INVENTION

The traditional cooking and baking industry experiences particular problems associated with the use of paper products, such as pad paper, in baking and cooking. In particular, the pad paper is difficult to peel from the bottom of the cooked and/or baked food product because the pad paper typically sticks together with the food during cooking and baking due to the penetration of oil and water from the food into the pad paper. Further, some of the food is often peeled away from the food product with the pad paper during removal of the pad paper, thus causing food to be wasted. Disposal of the pad paper also poses problems such as the waste of resources to the detriment of environmental protection.

Embodiments of the present invention solve the above-mentioned problems by providing a non-toxic silicone-gum product that can be used in place of traditional pad paper and may also be used repeatedly. In addition, embodiments of the present invention provide a process for manufacturing a silicone-gum product and processes for using the silicone-gum product of the present invention for cooking and baking food products.

According to embodiments of the present invention, a silicone-gum product includes a glass fiber layer positioned within a silicone rubber. The silicone-gum product may be used as a mat, mold, or other form in baking and cooking. For example, the silicone-gum product may be used as a muffin wrapper, a cake pan, a cooling mat, a baking sheet, or the like.

According to other embodiments of the present invention, a method of making a silicone-gum product is provided. A silicone rubber may be formed by reacting a diorgano-polysiloxane having an alkenyl group capable of linking to silicone with a cross-linking agent. In particular, a peroxide cross-linking agent may be used. Alternatively, an organo-hydropolysiloxane cross-linking agent may be used in the presence of a platinum catalyst. Once formed, a glass fiber layer is positioned between two or more silicone rubber layers and molded into a desired silicone-gum product shape that may be used for baking or cooking purposes.

### BRIEF DESCRIPTION OF THE DRAWINGS

FIG. 1 illustrates a cross-sectional view of a silicone-gum product of the present invention, comprising two silicone rubber layers and a glass fiber layer.

### DETAILED DESCRIPTION OF EMBODIMENTS OF THE PRESENT INVENTION

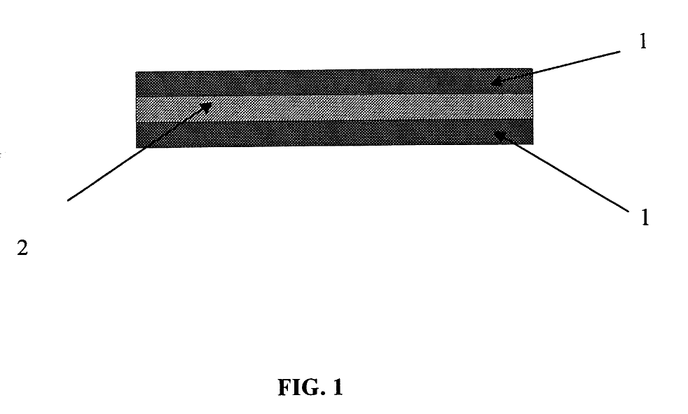

The silicone-gum product according to embodiments of the present invention comprises a glass fiber layer 2 positioned within silicon rubber, or between two silicone rubber layers 1 as illustrated in FIG. 1. The silicone-gum product according to embodiments of the present invention may be manufactured by machine-pressing a layer of glass fiber 2 between two layers of silicone rubber 1 and baking the combined product. The glass fiber layer provides the silicone-gum product with strength to support foods.

The silicone rubber 2 used in the silicone-gum product of the present invention can be prepared by mixing commercial raw material of siloxane with a cross-linking agent and reacting the resultant mixture in the presence of a catalyst. For example, the solid silicone rubber 1 may be obtained by mixing diorgano-polysiloxane having an alkenyl group capable of linking to silicone with a peroxide cross-linking agent, or a platinum catalyst, and an organo-hydropolysiloxane cross-linking agent, followed by a reaction of the resultant blend.

The diorgano-polysiloxane may have an alkenyl group capable of linking to silicone, which is preferably dimethylvinylsiloxane silicone-gum with a preferred polymerization degree of 7000 to 8000.

Examples of organo-hydropolysiloxane cross-linking agents that may be used with the present invention include trimethylsiloxy-capped methylhydropolysiloxane, trimethylsiloxy-capped dimethylsiloxane-methylhydrosiloxane copolymer, and dimethylphenylsiloxy-capped methylphenylsiloxane-methylhydrosiloxane copolymer.

The structure of the organo-hydropolysiloxane cross-linking agent used with the present invention preferably has the following structure:

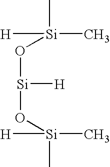

The organo-hydropolysiloxane cross-linking agent is used in an amount of about 0.1 to about 10% by weight, based on the weight of other raw materials.

The peroxide cross-linking agent used with the present invention may include benzoyl peroxide, bis(2,4-dichlorobenzoyl) peroxide, dicumyl peroxide, di-tert-butyl peroxide, sym-chlorobutyl peroxide, 2,5-dimethyl-2,5-di-tert-butylperoxy hexane, di-tert-butylperoxy peroxide, 2,5-dimethyl-2,5-bis(tert-butylperoxy) hexane or tert-butylcumyl peroxide. A preferred peroxide cross-linking agent is 2,5-dimethyl-2,5-di-tert-butylperoxy hexane, and a more preferred peroxide cross-linking agent is a peroxide cross-linking agent selected from the group of peroxide cross-linking agents having the trade names C-8, C-8A or C-8B, which are commercially available and manufactured by Shin-Etsu Silicone Co., Ltd. The amount of peroxide cross-linking agent used with the present invention may be an amount of about 0.3% to about 4% by weight, based on the weight of other raw materials in the silicone rubber 1.

Examples of a platinum catalyst, or Pt-catalyst, that may be used with the present invention include platinum black, chloroplatinic acid, platinum tetrachloride, chloroplatinic acid-olefin complex, chloroplatinic acid-methylvinylsiloxane complex or other platinum catalysts.

The process for manufacturing a silicone rubber may be achieved using different reaction mechanisms, such as the following:

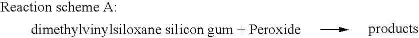

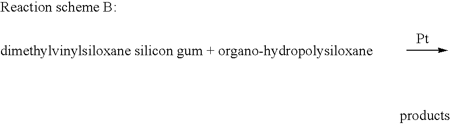

The products of Reaction scheme A are baked at between 120° C. and 220° C. for a time period of between about 1 and about 16 hours. The baked product may then be rinsed with boiling water for about 4 to about 16 hours and treated with ultrasonic energy in a 3-tank type of gas-phase ultrasonic rinsing machine, for example, an ultrasonic rinsing machine Model S&E-3036C, using an ultrasonic frequency of 28 KHz and an ultrasonic power of 21600W for about 5 to about 30 minutes, to obtain a silicon rubber to be used with embodiments of the present invention.

The products of Reaction scheme B are baked at between 120° C. and 220° C. for a time period of between about 1 and about 16 hours to obtain a silicone rubber to be used with embodiments of the present invention.

The silicone rubber used in the present invention may be molded in a number of different ways, including the use of compression molding methods and injection molding methods. In a compression molding process, an oil press may be used to mold the silicon rubber into the desired shape. Typically, compression molding is carried out between about 50 and about 250 tons of molding pressure at a molding temperature of between about 80° C. and about 250° C. The compression mold may be used for a time period of between about 60 to about 2000 seconds, depending upon the desired result and the amount of material being molded.

Injection molding is typically carried out under a pressure of about 10 to about 200 kilograms and at a temperature of between about 80° C. to about 250° C. for a period of time between about 60 and about 1000 seconds. Hot air curing may also be used to mold the products of the present invention. When hot-air curing is used, the materials are typically kneaded in a multi-roller. The kneaded blend may then be fed at a desired thickness to a baking oven at between 80° C. and 230° C. and molded in the oven for a time period between about 60 and about 200 seconds.

Commercial glass fiber can be used as the glass fiber in the silicone-gum product of the present invention. For example, commercial glass fiber such as Model numbers 7630, 7628M, 7628L, 2116, 1080 and the like, which are available from Hong Kong Glass Fibers Co., Ltd., may be used as glass fiber 2 in the present invention. Various properties for the types of glass fibers that may be used with embodiments of the present invention are illustrated in Table I.

TABLE I

| | | Model | | | | |
|---|---|---|---|---|---|---|
| Specification | | 7630 | 7628M | 7628L | 2116 | 1080 |
| Crude yarn | Warp | ECG67 | ECG75 | ECG75 | ECE225 | ECD450 |
| | | 1/0 | 1/0 | 1/0 | 1/0 | 1/0 |
| | Weft | ECG67 | ECG75 | ECG75 | ECE225 | ECD450 |
| | | 1/0 | 1/0 | 1/0 | 1/0 | 1/0 |
| Density | Warp | 42 ± 2 | 44 ± 2 | 44 ± 2 | 60 ± 2 | 60 ± 2 |
| Tip (ends/inch) | Weft | 33 ± 2 | 33 ± 2 | 31 ± 2 | 58 ± 2 | 47 ± 2 |
| Base weight (g/m²) | | 220 ± 5 | 208 ± 5 | 203 ± 5 | 105 ± 4 | 47.5 ± 2.5 |
| Thickness | | 0.185 ± 0.020 | 0.180 ± 0.020 | 0.173 ± 0.020 | 0.100 ± 0.012 | 0.055 ± 0.010 |
| (mm) | | | | | | |
| Tensile strength | Warp | ≧40 | ≧40 | ≧40 | ≧25 | ≧16 |
| Kg/inch | Weft | ≧30 | ≧30 | ≧30 | ≧22 | ≧9 |
| Treatment agent type | Epoxy- | Epoxy- | Epoxy- | Epoxy- | Epoxy- | Epoxy- |
| | compatible | compatible | compatible | compatible | compatible | compatible |
| | coupling | coupling | coupling | coupling | coupling | coupling |
| | agent | agent | agent | agent | agent | agent |
| Treatment agent | | 0.08 ± 0.04 | 0.08 ± 0.04 | 0.08 ± 0.04 | 0.12 ± 0.05 | 0.12 ± 0.05 |
| content (%) | | | | | | |

In embodiments of the present invention, the Model 1080 glass fiber, or a glass fiber having similar properties, is preferably used. The thickness of the glass fiber layer is preferably about 0.055 to about 1 mm, and more preferably between about 0.1 to about 0.2 mm. However, the thickness of the glass fiber layer may be adjusted or chosen for the intended use of the silicone-gum product being produced.

Silicone rubber 1 obtained according to the processes described herein may be pressed onto the glass fiber 2 using conventional machine-pressing methods. Typically, the machine-pressing methods comprise pressing silicone rubber 1 which has been mixed with a cross-linking agent into a thin sheet having a thickness of between about 0.5 and about 3 mm in a pressing machine. A glass fiber layer may be placed between two layers of the silicone rubber 1 to form a sandwich-like structure or form. The sandwich-like form of silicone rubber and glass fiber may be trimmed or cut to a desired size before putting the sandwich-like form on a hot-press die. The hot-press die, such as a hydraulic press, may be used to apply about 50 to about 250 tons of locking pressure to the sandwich-like form while heating the sandwich-like form continuously at a temperature of about 80 to about 230° C. for about 60 to about 6000 seconds. This process completes the molding of the glass fiber 2 within the silicone layers 1, producing the silicone-gum product of embodiments of the present invention.

Subsequently, the primary product obtained in this way is put into a baking oven and baked for a second time at about 100 to about 200° C., and preferably at about 200° C., for about 1 to about 16 hours, with about 4 hours being the preferred time for the second baking. The baked product may be cut into any desired size and shape. The thickness of the silicone rubber in the silicone-gum product is about 0.1 mm to about 2 mm, and preferably about 0.2 to about 1 mm.

The silicone-gum product obtained according to embodiments of the processes of the present invention is non-toxic. The silicone-gum products of embodiments of the present invention have been tested for safety by repeatedly contacting the silicone-gum products with oily and water-containing foods in accordance with the tests of 21 C.F.R. §177.2600 and the guidelines of the United States Food and Drug Administration (FDA) (the test is used to evaluate the safety of rubber products which repeatedly contact oily and water-containing foods). The results of such tests are illustrated in Table II.

TABLE II

| | | | CFR specification | |
|---|---|---|---|---|
| | Result(mg/inch²) | | (mg/inch²) | |
| | Extractive | | Distilled | |
| Test condition | Distilled water | Extractive n-hexane | water | n-hexane |
| i) Extracting first at the reflux | <1 | 5.8 | <20 | <175 |
| temperature for 7 hours | | | | |
| ii) Extracting again at the reflux | <0.5 | 1.4 | <1 | <4 |
| temperature for 2 hours | | | | |

The results illustrated in Table II show that the silicone-gum product of embodiments of the present invention complies with the United States FDA safety requirements for rubber products contacting oily foods and water-containing foods as specified in 21 C.F.R. §177.2600.

Therefore, the silicone-gum product of embodiments of the present invention can be used with food products.

The silicone-gum product of the present invention may be used as a pad for cooking, and as a backing for cooking and baking, various foods. A method of using the silicone-gum product according to embodiments of the present invention as a pad for food during cooking and baking involves putting formulated food materials on the silicone-gum product and then cooking and/or baking them. When the food is baked the silicone-gum product of the present invention can withstand the high temperatures associated with cooking and baking, such as temperatures of up to about 230° C.

The silicone-gum product according to some embodiments of the present invention used in baking and cooking can be easily removed from the cooked and/or baked food without removing the food, thus avoiding the waste of foods. In additional embodiments, the removed silicone-gum product can be used repeatedly, thus coinciding with the aim for environmental protection and preventing the further waste of paper in baking processes.

Furthermore, the silicone rubber of the present invention can also be used as a mold for cooking and/or baking foods. For example, the silicone-gum product of the present invention can be used as pads or molds for cooking various pastries, cakes, and/or breads.

Examples illustrating the present invention follow. The Examples are meant to be exemplary and are not meant to limit the scope of the present invention in any way.

### EXAMPLE 1

Commercial ShinEtsu KE551 silicone-gum raw material was mixed with 1% by weight of C8 bridging agent in a mixer. The resultant blend was kneaded and pressed into a thin silicone-gum sheet having a thickness of 1 mm using a roller. Subsequently, two pieces of the thin silicone-gum sheet were cut to a size of 400 mm by 300 mm. A commercial glass fiber, Model 1080, having a thickness of 0.055 mm and available from Hong Kong Glass Fiber Co., Ltd. was cut into 400 mm by 300 mm pieces. The cut glass fiber was placed in between two silicone-gum sheets in a sandwich-like form. The sandwich-like form was put on a die which had been preheated to 180° C. and was molded by vulcanizing at a temperature of 180° C. under 200 tons of locking pressure for 1000 seconds to obtain a sheet of silicone-gum product according to embodiments of the present invention having the dimensions of 400 mm by 300 mm by 2 mm.

### EXAMPLE 2

The commercial ShinEtsu KE551 silicone-gum raw material was mixed with 1% by weight of C8 bridging agent in a mixer. The resultant blend was kneaded and pressed into a thin silicone-gum sheet having a thickness of 3 mm using a roller. Subsequently, two pieces of the thin silicone-gum sheet were cut to a size of 600 mm by 450 mm. A commercially available glass fiber, Model 7630 available from Hong Kong Glass Fiber Co., Ltd., having a thickness of 0.185 mm was cut to a size of 600 mm by 450 mm. The glass fiber was placed between two silicone-gum sheets in a sandwich-like form. The sandwich-like form was put on a die which had been preheated to 230° C. and molded by vulcanizing at a temperature of 230° C. under 250 tons of locking pressure for 2000 seconds to obtain a sheet of silicone-gum product according to embodiments of the present invention having the dimensions 600 mm by 450 mm by 3 mm.

### EXAMPLE 3

The commercial ShinEtsu KE551 silicone-gum raw material was mixed with 1% by weight of C8 bridging agent in a mixer. The resultant blend was kneaded and pressed into a thin silicone-gum sheet having a thickness of 0.5 mm using a roller. Subsequently, two pieces of the thin silicone-gum sheet were cut to a size of 400 mm by 300 mm. A commercial glass fiber, Model 2116 available from Hong Kong Glass Fiber Co., Ltd., having a thickness of 0.1 mm was cut to a size of 400 mm by 300 mm. The glass fiber was placed between the two silicone-gum sheets in a sandwich-like form. The sandwich-like form was put on a die which had been preheated to 80° C. and was then molded by vulcanizing at a temperature of 80° C. under 50 tons of locking pressure for 60 seconds to obtain a sheet of silicone-gum product according to the present invention having the dimensions 400 mm by 300 mm by 0.5 mm.

### EXAMPLE 4

The commercial ShinEtsu KE551 silicone-gum raw material was mixed with 1% by weight of C8 bridging agent in a mixer. The resultant blend was kneaded and pressed into a thin silicone-gum sheet having a thickness of 2 mm using a roller. Subsequently, two pieces of the thin silicone-gum sheet were cut to a size of 700 mm by 500 mm. A commercial glass fiber, Model 7628M available from the Hong Kong Glass Fiber Co., Ltd., having a thickness of 0.180 mm was cut to a size of 700 mm by 500 mm. The glass fiber was placed in between the two silicone-gum sheets in a sandwich-like form. The sandwich-like form was put on a die which had been preheated to 200° C. and was then molded by vulcanizing at a temperature of 200° C. under 200 tons of locking pressure for 800 seconds to obtain a sheet of silicone-gum product according to embodiments of the present invention having the dimensions of 700 mm by 500 mm by 2 mm.

### EXAMPLE 5

A commercially available glass fiber, Model 2116 available from Hong Kong Glass Fiber Co., Ltd., having a thickness of 0.1 mm was cut to a size of 150 mm by 150 mm. Silicone-gum raw materials, available commercially as ShinEtsu KET-1001 A and B, were mixed. Both sides of the glass fiber were coated with the resultant mixture in an average thickness of about 1 mm. Subsequently, the glass fiber coated with the silicone-gum raw materials was put into a cake mold, which had been preheated to 120° C. and then molded by vulcanizing under 50 tons of locking pressure for 120 seconds to obtain a concave cake mold having a thickness of 0.7 mm. When the mold was used, the cake materials could be placed in the mold and baked in an oven at a temperature of 180° C. to bake the cake materials into a cake without using any support of a metal mold.

### EXAMPLE 6

A commercially available glass fiber, Model 7630 available from Hong Kong Glass Fiber Co., Ltd., having a thickness of 0.185 mm was cut into a size of 180 mm by 180 mm. Commercially available ShinEtsu KET-1001 silicone-gum raw materials A and B were mixed. Both sides of the glass fiber were coated with the resultant blend of silicone-gum raw materials in an average thickness of about 3 mm. Subsequently, the glass fiber coated with the silicone-gum raw materials was put in a cake mold that had been preheated to 230° C. The silicone-gum raw material coated glass fiber was then molded by vulcanizing under 250 tons of locking pressure for 2000 seconds to obtain a shallow cake mold having a thickness of 2 mm, which could be used for baking a cake. When the mold was used, cake materials were placed in the mold and the mold containing cake materials was put into a baking oven at a temperature of 230° C. to bake the cake materials in the cake mold without using any support of a metal mold.

### EXAMPLE 7

A commercially available glass fiber, Model 7628L available from Hong Kong Glass Fiber Co., Ltd., having a thickness of 0.173 mm was cut into a size of 160 mm by 160 mm. Commercially available ShinEtsu KET-1001 silicone-gum raw materials A and B were mixed. Both sides of the glass fiber were coated with the resultant mixture of silicone-gum raw materials in an average thickness of about 1.8 mm. Subsequently, the silicone-gum material coated glass fiber was put into a cake mold that had been preheated to 180° C. The silicone-gum material coated glass fiber was then molded by vulcanizing under 150 tons of locking pressure for 500 seconds to obtain a concave cake-baking mold having a thickness of 1.4 mm. When the mold was used, cake materials to be baked were placed in the mold and the mold containing the cake materials was put into a baking oven at a temperature of 200° C. to bake the cake materials into a cake without using any support of metal mold.

What is claimed is:

1. A silicone-gum product, comprising:
silicone rubber; and
a glass fiber layer positioned within said silicone rubber.

2. The silicone-gum product of claim 1, wherein said silicone rubber comprises at least two layers of silicone rubber molded together, said glass fiber layer molded between said at least two layers of silicone rubber.

3. The silicone-gum product of claim 1, wherein said silicone rubber comprises at least one silicone rubber layer having a thickness of between about 0.1 mm and about 2 mm.

4. The silicone-gum product of claim 1, wherein said glass fiber layer comprises at least one glass fiber layer having a thickness of between about 0.055 mm and about 1 mm.

5. The silicone-gum product of claim 1, wherein said silicone rubber has a thickness of about 0.2 mm to about 1 mm, and wherein said glass fiber layer has a thickness of between about 0.1 mm and about 0.2 mm.

6. The silicone-gum product of claim 1, wherein said glass fiber layer comprises a glass fiber selected from the group consisting of glass fiber Models 7630, 7628M, 7628L, 2116, and 1080, sold by Hong Kong Glass Fiber Co., Ltd.

7. The silicone-gum product of claim 1, wherein said glass fiber layer comprises glass fiber Model 1080 produced by Hong Kong Glass Fiber Co., Ltd.

8. A silicone-gum product, comprising:
a silicone rubber formed from a diorgano-polysiloxane having an alkenyl group capable of linking to silicone and a cross-linking agent; and
a glass fiber layer disposed within said silicone rubber.

9. The silicone-gum product of claim 8, wherein said cross-linking agent comprises a peroxide.

10. The silicone-gum product of claim 9, wherein said peroxide is selected from the group consisting of benzoyl peroxide, bis(2,4-dichlorobenzoyl)peroxide, dicumyl peroxide, di-tert-butyl peroxide, sym-chlorobutyl peroxide, 2,5-dimethyl-2,5-di-tert-butylperoxy hexane, di-tert-butylperoxy peroxide, 2,5-dimethyl-2,5-bis(tert-butylperoxy)hexane, and tert-butylcumyl peroxide.

11. The silicone-gum product of claim 9, wherein said peroxide is 2,5-dimethyl-2,5-di-(tert-butylperoxy) hexane.

12. The silicone-gum product of claim 9, wherein said peroxide is in an amount of about 0.3 percent to about 4 percent by weight based upon the weight of the reagents used to form said silicone rubber.

13. The silicone-gum product of claim 8, wherein said diorgano-polysiloxane having an alkenyl group capable of linking to silicone is dimethylvinylsiloxane silicone-gum.

14. The silicone-gum product of claim 8, wherein said cross-linking agent comprises an organo-hydropolysiloxane.

15. The silicone-gum product of claim 14, further comprising a platinum catalyst.

16. The silicone-gum product of claim 14, wherein said organo-hydropolysiloxane cross-linking agent is in an amount of about 0.1 percent to about 10 percent by weight based upon the weight of the reagents used to form said silicone rubber.

17. A method of making a silicone-gum product, comprising:
positioning a glass fiber layer between a first silicone rubber layer and a second silicone rubber layer;
pressing said first silicone rubber layer and said second silicone rubber layer together in a machine-pressing form to form a sandwich structure comprising said first silicone rubber layer; said glass fiber layer, and said second silicone rubber layer; and
bake-molding said sandwich structure.

18. The method of claim 17, further comprising performing a secondary baking of said bake-molded sandwich structure.

19. The method of claim 17, wherein said positioning of a glass fiber layer between a first silicone rubber layer and a second silicone rubber layer comprises:
mixing silicone rubber with a cross-linking agent;
pressing said silicone rubber and cross-linking agent mixture into a thin sheet having a thickness of about 0.5 mm to about 3 mm;
cutting a first sheet of silicone rubber and a second sheet of silicone rubber from said thin sheet;
placing said glass fiber layer between said first sheet of silicone rubber and said second sheet of silicone rubber; and
cutting said first sheet of silicone rubber, said glass fiber layer, and said second sheet of silicone rubber to a desired sandwich form.

20. The method of claim 19, wherein said pressing of said first silicone rubber layer and said second silicone rubber layer together in a machine-pressing form to form a sandwich structure comprises:
placing said desired sandwich form in a hot-die;
applying a hydraulic press at a pressure of about 50 to about 250 tons to said desired sandwich form in said hot-die; and
continuously heating said desired sandwich form in said hot-die at a temperature of between about 80° C. and about 230° C. for about 60 to about 6000 seconds to form said sandwich structure.

21. The method of claim 20, further comprising:
removing said sandwich structure from said hot-die; and
baking said sandwich structure in an oven at a temperature between about 100° C. and about 200° C. for about 1 to 16 hours, after having bake-molded said sandwich structure.

22. The method of claim 17, further comprising cutting said sandwich structure into a desired shape.

23. The method of claim 17, further comprising forming said sandwich structure into a mold or pad for cooking or baking food.

24. The method of claim 17, wherein said bake-molding of said sandwich structure comprises baking said sandwich structure at a temperature between about 80° C. and about 200° C. for about 100 to about 4000 seconds.

25. The method of claim 18, wherein said performing of a secondary baking of said bake-molded sandwich structure comprises baking said bake-molded sandwich structure at a temperature between about 100° C. and about 200° C. for about 1 to about 16 hours.

26. The method of claim 25, wherein said baking temperature is about 200° C.

27. The method of claim 25, wherein said baking time is about 4 hours.

28. A method for cooking food, comprising:
placing a food material on a silicone-gum product comprising a glass fiber layer positioned within silicone rubber; and
cooking the food material.

29. The method of claim 28, wherein the cooking of the food material comprises baking the food material.

30. The method of claim 28, further comprising removing the silicone-gum product from the cooked food material.

31. The method of claim 30, wherein the silicone-gum product is removed from the cooked food material without a substantial amount of the cooked food material sticking to the silicone-gum product.

32. The method of claim 30, further comprising:
placing a second food material on the silicone-gum product; and
cooking the second food material.

33. A method for cooking food, comprising:
placing a food material in a silicone-gum product mold comprising a glass fiber layer positioned within silicone rubber; and
cooking the food material.

34. The method of claim 33, wherein the cooking of the food material comprises baking the food material.

35. The method of claim 33, wherein the silicone-gum product mold is used in the absence of a metal mold.

36. The method of claim 33, further comprising removing the silicone-gum product mold from the cooked food material.

37. The method of claim 36, wherein the silicone-gum product mold is removed from the cooked food material without a substantial amount of the cooked food material sticking to the silicone-gum product mold.

38. The method of claim 36, further comprising:
placing a second food material in the silicone-gum product mold; and
cooking the second food material.
